(19) United States
(12) Patent Application Publication
(10) Pub. No.: US 2002/0030886 A1
(43) Pub. Date: Mar. 14, 2002

(54) Microscope

(75) Inventors: Joerg Bewersdorf, Heidelberg (DE); Hilmar Gugel, Dossenheim (DE)

Correspondence Address: Glenn Law, FOLEY & LARDNER, Washington Harbour, 3000 K Street, N.W., Suite 500, Washington, DC, 20007-5109, US

(73) Assignee: LEICA MICROSYSTEMS HEIDELBERG GmbH.

(21) Appl. No.: 09/951,397

(22) Filed: Sep. 14, 2001

(30) Foreign Application Priority Data
Sep. 14, 2000 (DE) 100 45 837.8

(51) Int. Cl. G02B 21/00; G02B 21/06

(52) U.S. Cl. 359/387; 359/385; 359/368

(57) ABSTRACT

The present invention concerns a microscope having an illuminating beam path (1) of a light source (2), a detected beam path (3) of a detector (4), a component (5) combining the detected beam path (3), and at least two microscope objectives (7, 8) directed onto the specimen (6). In order to achieve enhanced detection efficiency, the present invention is characterized in that an optical component (14) arranged in the beam path (1, 3) has the property of acting on a portion of the illuminating and/or detected beam cross section in such a way that the combined detected light (15, 16) is guided in largely lossless fashion to the detector (4). Alternatively thereto, the microscope according to the present invention is characterized in that a polarizing beam splitter (19), arranged in the beam path (1, 3) and acting on the entirety of the illuminating and/or detected beam cross section, is provided.

### CROSS REFERENCE TO RELATED APPLICATIONS

This invention claims priority of the German patent application 100 45 837.8 which is incorporated by reference herein.

### FIELD OF THE INVENTION

The present invention concerns a microscope. Especially, the invention refers to a microscope which provides efficient light usage for illumination and detection.

### BACKGROUND OF THE INVENTION

Microscopes of the generic type, in particular microscopes in which two microscope objectives directed onto the specimen are provided, have been known from practical use for some time.

U.S. Pat. No. 4,621,911, for example, discloses a standing wave field microscope in which a standing wave field serving to illuminate a specimen is created by the interference of two light beams proceeding in collimated fashion. This standing wave field possesses planes of equal illumination intensity oriented parallel to the focal plane of the microscope objectives, the illumination intensity varying from a maximum illumination value to a minimum illumination value, the alternating illumination variation continuing periodically along the optical axis of the microscope objectives. With this interferometric illumination method, fluorescent specimens can be excited to fluoresce in accordance with the illumination pattern, thereby allowing an improvement in resolution to be achieved.

EP 0 491 289 A1 discloses a double confocal scanning microscope in which a specimen is illuminated in point-like fashion by two microscope objectives arranged opposite one another. This two-sided illumination also causes an interference pattern to form, so that in this way as well, an increase in axial resolution can be achieved.

U.S. Pat. No. 5,671,085 discloses a microscope that also excites fluorescence in a specimen using two microscope objectives, arranged opposite one another, with bright-field incident illumination. In this context as well, the illuminating and/or detected light can be caused to interfere, once again allowing axial resolution improvements to be attained.

DE 196 29 725 A1 discloses a double-objective system for a microscope, in particular for a scanning microscope. This makes provision for two microscope objectives, which are directed onto the specimen and whose optical axes enclose an angle that is approximately 90 degrees. With this double-objective system it is possible, in particular, to excite fluorescence in fluorescent specimens with a point-like illumination pattern of almost isotropic shape. Here as well, resolution improvements can be achieved.

The microscopes of the generic type are, however, problematic in terms of detection efficiency, since the specimen light collected by the two objectives is combined using a beam splitter at which approx. 50% of the detected light coming from each objective is lost. The reason for this is the use of, for example, a 50:50 beam splitter, at which only half the intensity of each detected light beam can pass toward the detector while appropriate delivery to the detector is not possible for the other half of the light to be detected. The resolution of one of the aforementioned generic microscopes is therefore increased, but the detection efficiency is no greater than when a single microscope objective is used. But because, especially in confocal fluorescent microscopy, an increase in resolution is associated with a smaller illuminated volume, the fluorescent light coming from the specimen derives from a smaller illuminated volume, the further result being that fewer fluorescent molecules are excited in that smaller illuminated volume, and the emitted fluorescent light output is accordingly reduced. This results in a decrease in the fluorescent photon yield and thus in the signal-to-noise ratio.

### SUMMARY OF THE INVENTION

It is therefore the object of the present invention to describe and further develop a microscope with an enhanced detection efficiency, in particular with maximum resolution.

The above object is achieved by a microscope comprising:

a light source an illumination beam path,

a detector defining a detection beam path,

at least two microscope objectives arranged on opposite sides of a common focal plane within a specimen and each collecting detection light emanating from the specimen, and

an optical component combining the detection light into a detection beam path and wherein the optical component acts on a portion of cross section of the illuminating beam path and combines the detection light such that the combined detection light is guided in a largely lossless fashion to the detector.

What has been recognized according to the present invention is firstly that the loss of approx. 50% of the detected light which occurs at the conventional component combining the detected beam path can be avoided if the component combining the beam path is arranged in the beam path in such a way that it acts only partially on the entire illuminating and/or detected beam cross section. As a result, the detected light coming from a microscope objective can pass in almost lossless fashion through the optical component combining the detected beam path, whereas the detected light coming from the other microscope objective is reflected at the optical component. In the case where the illuminating beam and detected beam are proceeding almost identically at the optical component, the illuminating light is guided in accordance with the effective portion of the optical component to the microscope objectives for specimen illumination. Especially in the context of a double confocal scanning microscope, because of the particular arrangement of the component combining the detected light, the mirrors that usually reflect the illuminating or detected light toward the microscope objectives must be arranged at another point.

In a preferred embodiment provision is made, in particular for the creation of optimum illumination interference patterns or detection interference phenomena, for the effective portion of the optical component to influence substantially 50% of the entire beam cross section. Thus substantially the entire quantity of light is guided to each microscope objective, for example for illumination, so that the light beams that come from different directions and are superimposed in the specimen region can be superimposed to cause interference. Only when the light intensity of the two light beams is approximately equal can a maximum modulation intensity be achieved, i.e. complete extinction or maximum amplification.

Concretely, the optical component could comprise a mirror, a dichroic beam splitter, and/or a polarizing beam splitter. In the simplest case, a mirror whose property is to act as a mirror on approx. 50% of the entire beam cross section could be provided. The use of a dichroic beam slitter or a polarizing beam splitter would result in a selective action of the optical component. A dichroic beam splitter could, for example, act only on the detected beam path, specifically if it possesses a high transmittance with regard to the wavelength used for the illuminating light and a high reflectance with regard to the detected light. Also, for example, one half of the optical component could comprise a mirror, and the other half a polarizing beam splitter. In this case the one half would have the property of acting as a mirror on the illuminating and/or detected beam cross section, and the other half correspondingly that of a polarizing beam splitter. This would make it possible, for example, to implement a polarizing microscope with enhanced detection efficiency.

The optical component could be coated or mirror-coated only partially, i.e. only to a degree corresponding to the effective portion. Concretely, the optical component could comprise a partially mirror-coated glass plate or a partially mirror-coated or partially coated substrate.

An almost optimum illumination pattern can be achieved if the optical component divides the illuminating light beam in such a way that the entrance pupils of the microscope objectives are at least largely illuminated. For this purpose, for example, the illuminating beam diameter could be correspondingly enlarged so that the entirety of the entrance pupils of the microscope objectives is illuminated, and the maximum illuminating aperture of the microscope objectives is therefore utilized in terms of specimen illumination.

In a preferred embodiment, the optical component is arranged in the beam path in such a way that the detected light coming from the specimen proceeds, after the optical component, in at least largely parallel fashion. A corresponding detector could analogously be arranged in this detected light direction proceeding in parallel fashion. Almost lossless detection of the detected light coming from the specimen would be the particularly advantageous result of this action. In the context of a double confocal scanning microscope arrangement, for example, it is thereby possible to achieve, even with a reduced illumination volume, a maximum detected light yield and a maximum signal-to-noise ratio.

In a particularly preferred embodiment, the optical component is arranged in a plane corresponding to the entrance pupil of at least one microscope objective. If the context is that of a scanning microscope in which the light beam is deflected in order to scan the specimen, then in a plane corresponding to the entrance pupil the light beam is merely tilted and is not deflected perpendicular to the propagation direction. The portion of the optical component acting on the illuminating or detected beam cross section is thus constant if the optical component is arranged in a plane corresponding to the entrance pupil.

The object of the present invention is accomplished as well by a microscope comprising:

a light source defining an illumination beam path;

a detector defining a detection beam path,

at least two microscope objectives arranged on opposite sides of a common focal plane within a specimen and each collecting detection light emanating from the specimen, and

an optical component combining the detection light into a detection beam path and wherein the optical component is a polarizing beam splitter and acts on the entirety of cross section of the illumination and detection beam path.

What has been recognized according to the present invention is firstly that an efficient detected light yield is possible with the generic microscope configuration in transmitted-light mode as well, if the illuminating light serving to illuminate the specimen illuminates the specimen almost entirely from one microscope objective, and the detected light is collected almost exclusively from the other microscope objective and conveyed to the detector. In this context, the polarizing beam splitter is introduced into the optical beam path in place of the optical component at which the illuminating beam path and/or detected beam path is divided or combined. The polarizing beam splitter acts on the entirety of the illuminating and/or detected light cross section. If the light of the light source is linearly polarized and the polarization direction of the polarizing beam splitter is identical thereto, the illuminating light can pass almost without impediment through the polarizing beam splitter. This illuminating light is then directed via one microscope objective for illumination of the specimen, and if the second microscope objective is appropriately arranged can pass through the latter and then once again, by way of corresponding deflection mirrors, strike the polarizing beam splitter, where it can again pass through the polarizing beam splitter so as thereby to emerge from the overall beam path. Circulation of the illuminating light in the opposite direction is for the most part effectively prevented by the use of the polarizing beam splitter accompanied by a suitable alignment of the polarization direction of the illuminating light, since the light coming from the light source and directly striking the polarizing beam splitter is essentially not reflected thereat.

In a preferred embodiment, a λ/2 plate that influences substantially 50% of the beam cross section is arranged between the light source and the beam splitter. Half the cross section of the illuminating beam is thus subjected to a change in phase or polarization equal to 90 degrees. In particularly advantageous fashion, the λ/2 plate is arranged in a plane corresponding to an entrance pupil of at least one microscope objective. In beam-deflecting microscope systems, no lateral beam deflection occurs in a plane corresponding to an entrance pupil of at least one microscope objective; the beam is merely tilted therein. A λ/2 plate arranged between light source and beam splitter and acting substantially on half the beam cross section would accordingly, and advantageously, have the same beam cross section passing through it in all beam deflection states.

This microscope according to the present invention implements a transmitted dark-field polarizing microscope, since all of the illuminating light whose polarization direction has not been influenced is blocked out of the illuminating beam path at the polarizing beam splitter. Only the portion of the light whose polarization state has been modified or influenced by the specimen is reflected at the polarizing beam splitter and proceeds in a direction opposite to the illuminating beam path, thus remaining in the microscope beam path.

In particularly advantageous fashion, at least one means influencing the polarization direction is provided in a beam path segment between the beam splitter and a microscope objective. Concretely, the means could comprise one λ/2 plate or two λ/4 plates; in the latter case one λ/4 plate could be arranged in each beam path segment. The polarization direction of the illuminating light is thereby rotated 90 degrees (when one λ/2 plate or two λ/4 plates are used) as the divided beam path passes through, so that the illuminating light passing through the microscope objectives is now reflected at the polarizing beam splitter and thus remains in the beam path. This feature creates a transmitted-light polarizing microscope in bright-field mode: only light whose polarization property is influenced by the specimen emerges from the beam path.

The constituents emerging from the beam path—with or without the use of the means in the beam path segment influencing the polarization direction—could be detected with a corresponding detector, the detector being arranged, with respect to the light passing through one microscope objective, in the transmission direction at the polarizing beam splitter.

For detection of the illuminating light that does pass along the beam path, there is arranged between the detector and the λ/2 plate a further beam splitter by way of which the light coming from the specimen can be detected. In particular, this beam splitter can also be a polarizing beam splitter.

In a concrete embodiment, provision is made for filters that are to be arranged in the beam path, and means influencing polarization, to be capable of being integrated into the beam splitter. This procedure yields a compact design and minimizes alignment effort. In general, however, it will not be possible to integrate into the beam splitter all the filters provided in the beam path and all the polarization-influencing means.

At least one laser is provided as the light source for the microscope according to the present invention. This could be a gas laser, solid-state laser, diode laser, or fiber laser. The use of an OPO (optically parameterized oscillator) would also be conceivable. For multi-photon fluorescent excitation of suitable fluorescent markers in particular, provision is made for the use of a laser light source that emits pulsed light.

A lamp that is usually used in conventional microscopy for illumination purposes could also serve as the light source. This could be a mercury or xenon high-pressure vapor discharge lamp.

In a preferred embodiment, the illuminating light is focused into the specimen with one or two microscope objectives. Concretely, this could involve confocal illumination or confocal illumination and detection. For scanning a specimen that extends in three dimensions, it is provided that the illumination focus can be moved relative to the specimen by deflection of the illuminating light beam. Beam deflection is performed, in this context, by a beam deflection apparatus. The detected light intensity value is allocated to a corresponding local coordinate as a function of the current deflection state of the beam deflection apparatus, by which means a two- or three-dimensional image of the specimen can be acquired and stored. As an alternative to deflection of the illuminating beam, the specimen could also be moved relative to the illumination focus, for example by the fact that the microscope stage which accommodates the specimen is moved in meander fashion in two different dimensions. In this case the measured intensity of the light coming from the specimen is allocated to the local coordinate that corresponds to the instantaneous stage position.

In an alternative embodiment, provision is made for the illuminating light to illuminate a specimen plane. This corresponds to a bright-field illumination that could be implemented in the form of a Kohler illumination. Detection could accordingly also be performed in planar fashion.

For both embodiments of the illumination and detection system, it is provided that the detected light is reflected light, transmitted light, and/or fluorescent light. The fluorescent light could have been generated with multi-photon fluorescent excitation processes. The reflected light or transmitted light could be detected as a function of polarization properties, thus making possible a polarizing microscope mode.

A camera having a CCD chip could serve as planar detector. For linear illumination or detection, a CCD linear array could serve as detector. Point-like detection could be accomplished with a photomultiplier, a photodiode, and/or an avalanche photodiode.

The microscope objectives could be arranged opposite one another with respect to the specimen or to a common focal plane. This would make it possible to implement microscopes in accordance with the microscope arrangements known from U.S. Pat. No. 4,621,911, EP 0 491 289 A1, and U.S. Pat. No. 5,671,085. Alternatively thereto, the microscopes could be arranged in such a way that the optical axes of two microscope objectives enclose between them an angle that is between 0 and 180 degrees. This would make it possible to implement a microscope arrangement known from DE 196 29 725 A1.

In a preferred embodiment, the microscope is configured as a scanning microscope, preferably as a confocal scanning microscope. In a particularly preferred embodiment, the microscope is configured as a double confocal scanning microscope, for example as known in principle from EP 0 491 289 A1. A configuration of the microscope in the form of a standing wave field microscope, for example as known from U.S. Pat. No. 4,621,911; or an I⁵M, I³M, or I²M microscope, as known for example from U.S. Pat. No. 5,671,085, would also be conceivable. The microscope could furthermore be configured as a theta microscope, as disclosed by DE 196 29 725 A1.

To generate interferences, provision is made for the coherence length of the illuminating and/or detected light to be greater than or equal to the path length difference between the respective path segments from the microscope objective to the optical component and beam splitter. Such is usually the case when a laser is used as a light source, since most lasers have a coherence length of approx. 1 m or greater. If a conventional lamp, for example a mercury high-pressure vapor discharge lamp, is used, then in order to generate illuminating interferences the optical distances of the two partial beam paths would need to be of almost identical length, differing in their path length by a maximum of approx. 1 μm.

If no interferences of the illuminating and/or detected light are to be generated, the coherence length of the illuminating and/or detected light is less than the path length difference between the respective path segments from the microscope objective to the optical component and beam splitter.

Very generally, the illuminating and/or detected beam path could be capable of being tuned to the coherence properties of the illuminating and/or detected light. Usually the coherence properties of the illuminating and/or detected light are taken into account in the design of the beam path during the development phase of the microscope system. If a further light source that has differing coherence properties is subsequently adapted to an existing system, the possibility of being able to tune the illuminating and/or detected beam path to the coherence properties of the new light source is extremely advantageous. Concretely, displaceably arranged mirrors and optical components could be provided, allowing tuning of the beam paths to a certain degree.

Provision is made for at least one phase-modifying means to be arranged in a beam path segment between the optical component or beam splitter and the microscope objective. With the aid of this phase-modifying means it is possible, especially in the context of an interference microscope configuration, to modify the phase position of the light passing through the one beam path segment relative to the phase position of the light passing through the other beam path segment. It is thereby possible, for example, to influence the illumination interference pattern in such a way that constructive interference is present in the specimen region or in the focal plane. Additionally or alternatively, a phase-modifying means could be provided with which the phase relationship of the illuminating and/or detected light is modifiable for different points in the focal plane. This phase-modifying means is relevant principally for microscope configurations that illuminate or detect an entire specimen plane, such as is the case, for example, with the standing wave field microscope or the I⁵M, I³M, or I²M microscope.

Fine adjustment of the overall beam path could be accomplished, for example, with the aid of at least one device for defined displacement and/or tilting of a microscope objective. In this context, one microscope objective could be displaceable relative to the other in the X, Y, and Z direction, and arranged tiltably with respect to its optical axis in two directions perpendicular to one another. The displacement or tilting of a microscope objective could be accomplished by means of piezoelements.

For correction of the optical components inserted into the beam path and acting only partially thereon, provision is made for at least one dispersion-modifying means that is arranged in a beam path segment between the optical component or beam splitter and the microscope objective. These means could be, for example, glass elements which exhibit a dispersion that is identical or opposite to the dispersion caused by the other component or components in the beam path.

In a concrete embodiment, provision is made for the illuminating light to be capable of being at least partially, preferably entirely, blocked out of the beam path in front of a microscope objective. In the context, for example, of linear polarization of the illuminating light, this could be implemented by way of a polarizer, if the polarizer is arranged in front of a microscope objective in its transmitting position perpendicular to the polarization direction of the linearly polarized light. An angular adjustment of the polarizer over a range from 0 to 90 degrees allows for minimum up to maximum transmission of the illuminating light through the corresponding microscope objective.

In a preferred embodiment, a further detector is arranged after the optical component or beam splitter. This further detector could detect the additional portion of the light that, despite precautions according to the present invention for efficient detection, nevertheless emerges from the illuminating and/or detected beam path. In the case of transmitting polarizing microscopy in particular, the additional detector could detect the light that is or is not modified in terms of its polarization direction by the specimen, depending on whether or not means for influencing the polarization direction are provided in the partial beam paths.

If a polarizing beam splitter cube is used as the component that divides or combines the illuminating and/or detected beam path, one lateral surface of the polarizing beam splitter is advantageously at least partially mirror-coated. This could be the lateral surface through which light does not pass when the transmission microscope is used according to the present invention. The detected light that would no longer be accessible to the detector after passing through this surface is thus reflected back into the beam path, so that after a further pass it can be conveyed at least partially to the detector.

### BRIEF DESCRIPTION OF THE DRAWINGS

There are various ways of advantageously embodying and developing the teaching of the present invention. In conjunction with the explanation of the preferred exemplary embodiments of the invention with reference to the drawings, an explanation is also given of generally preferred embodiments and developments of the teaching. In the drawings:

FIG. 1 schematically depicts a beam path of a microscope of the generic type;

FIG. 2 schematically depicts a first exemplary embodiment of a microscope according to the present invention;

FIG. 3 schematically depicts a second exemplary embodiment of a microscope according to the present invention;

FIG. 4 schematically depicts a further exemplary embodiment of a microscope according to the present invention; and

FIG. 5 schematically depicts a microscope according to the present invention incorporated into the overall system.

### DETAILED DESCRIPTION OF THE INVENTION

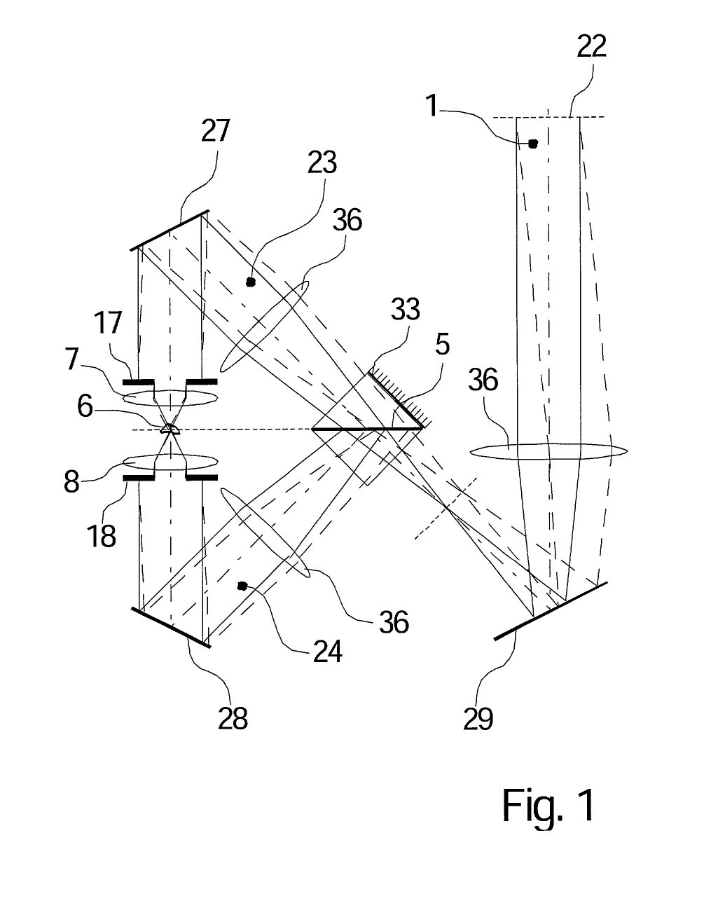

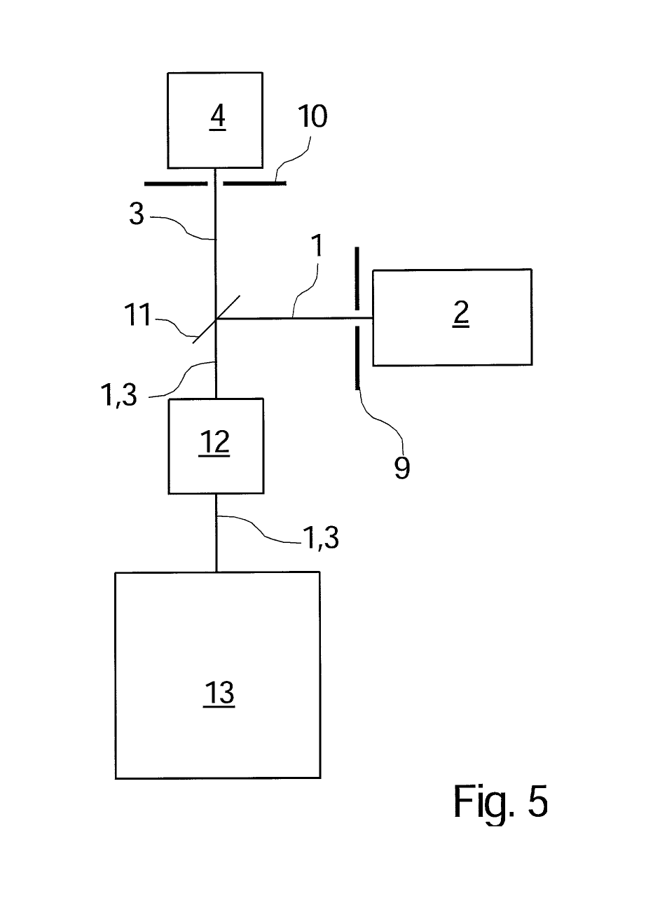

FIGS. 5 and 1 show a microscope having an illuminating beam path 1 of a light source 2, a detected beam path 3 of a detector 4, a component 5 combining the detected beam path 3, and two microscope objectives 7, 8 directed onto specimen 6.

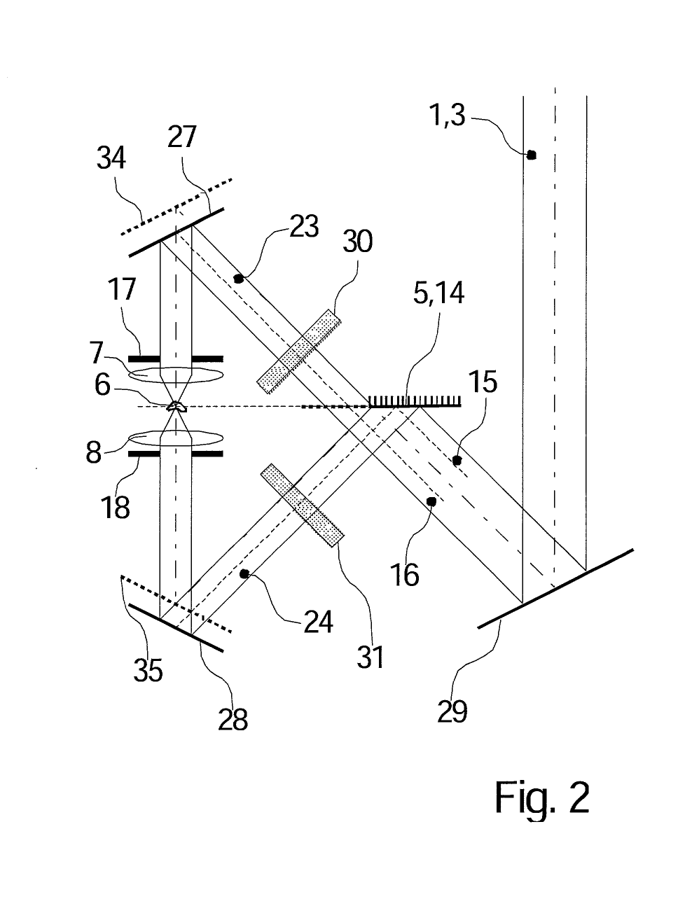

The microscope shown in FIG. 5 is a confocal scanning microscope; excitation pinhole 9 corresponds optically to detection pinhole 10, and both correspond optically to the focal plane of the microscope objectives. Illuminating beam path 1 is coaxially combined with detected beam path 3 by means of beam splitter 11. Beam deflection apparatus 12 deflects the illuminating and deflected light beam in two directions that are substantially perpendicular to one another, so that a specimen 6 can be scanned two-dimensionally. Microscope module 13 shown schematically in FIG. 5 schematically represents one of the microscope modules shown in FIGS. 2 through 4.

FIG. 2 shows that the microscope according to the present invention has a component 14, arranged in beam path 1, 3, whose property is to act on a portion of the illuminating and detected beam cross section in such a way that the combined detected light 15, 16 is conveyed in largely lossless fashion to detector 4.

Optical component 14 influences substantially 50% of the overall beam cross section, in particular, on the detection side, the region of detected light 15. Optical component 14 is configured as a mirror, the side facing toward the detected light in region 15 being a mirror-coated layer that is applied onto a mirror-coated glass plate. The region of the non-coated glass plate is shown in dotted fashion, and detected light 16 passes through it.

Optical component 14 divides illuminating beam 1 in such a way that entrance pupils 17, 18 of the two microscope objectives 7, 8 are at least largely illuminated. Original mirror positions 34, 35 (drawn with dotted lines) of mirrors 27, 28, which correspond to the mirror positions of the arrangement of FIG. 1, would not be suitable for complete illumination of entrance pupils 17, 18 of the two microscope objectives 7, 8. The two mirrors 27, 28 are accordingly located in the position shown in FIG. 2.

Light 15, 16 coming from specimen 6 proceeds in parallel fashion after the optical component.

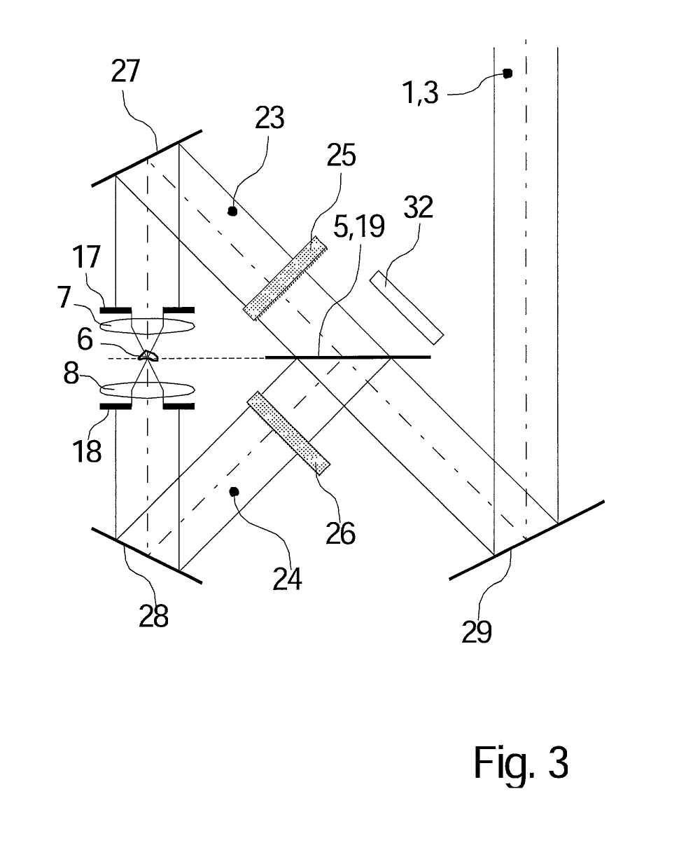

FIGS. 3, 4, and 5 show a microscope having an illuminating beam path 1, a light source 2, a detected beam path 3 of a detector 4, a component 5 combining detected beam path 3, and two microscope objectives 7, 8 directed onto specimen 6.

According to the present invention, a polarizing beam splitter 19, arranged in the beam path and acting on the entirety of the illuminating and/or detected beam cross section, is provided.

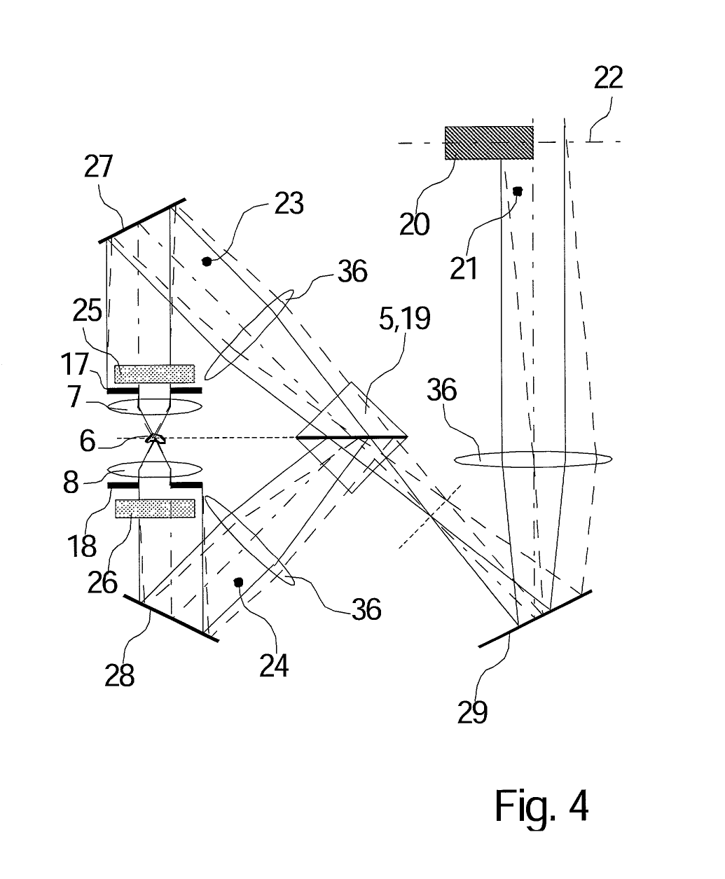

In FIG. 4, there is arranged between the light source (not shown in this Figure) and polarizing beam splitter 19 a λ/2 plate 20 that influences substantially 50% of the beam cross section, labeled with the reference character 21.

λ/2 plate 20 is arranged in a plane 22 corresponding to entrance pupils 17, 18 of the two microscope objectives 7, 8. In FIGS. 3 and 4, respective means 25, 26, which are configured in the form of λ/4 plates and influence the polarization of the light, are provided in each partial beam path 23, 24.

The exemplary embodiment of FIG. 3 shows a polarizing transmission microscope in which linearly polarized illuminating light 1 of light source 2 strikes polarizing beam splitter 19. As a result of the orientation of the polarization direction of illuminating light 1, illuminating light 1 can pass through the polarizing beam splitter in almost lossless fashion, and traverses λ/4 plate 25 in the direction of mirror 27. Mirror 27 reflects illuminating light 1 toward microscope objective 7, which focuses illuminating light 1 into specimen 6. Illuminating light 1 that has passed through specimen 6 is collected by microscope objective 8 and directed toward mirror 28. The transmitted light reflected at mirror 28 passes through a further λ/4 plate 26, after which the transmitted light substantially possesses a polarization direction that is perpendicular to the polarization direction of illuminating light 1. The rotation of the polarization direction is brought about by the two λ/4 plates 25, 26. Because of its rotated polarization direction, the transmitted light is reflected at polarizing beam splitter 19 toward mirror 29, which in turn reflects the transmitted light toward detector 4.

FIG. 4 shows a confocal polarizing transmission microscope with which specimen 6 is illuminated from both sides, i.e. from microscope objective 7 and microscope objective 8.

Located in illuminating beam path 1 of the microscope module shown in FIG. 4 is a λ/2 plate 20, arranged in plane 22, which influences approx. 50% of the beam cross section of illuminating beam path 1. The polarization direction of the linearly polarized light passing through λ/2 plate 20 is thus rotated 90 degrees. Illuminating light 1 reflected at mirror 29 strikes polarizing beam splitter 19, which is aligned and oriented in such a way that it transmits toward mirror 27 the light passing through the λ/2 plate, and reflects to mirror 28 the light that does not pass through the λ/2 plate. This illuminating light in turn passes through respective λ/4 plates 25 and 26 that are arranged in partial beam paths 23 and 24 in front of microscope objectives 7, 8. The illuminating light passing along partial beam path 23, once it has passed through first λ/4 plate 25, microscope objective 7, specimen 6, microscope objective 8, and second λ/4 plate 26, is rotated a further 90 degrees. This transmitted light is then reflected at mirror 28 toward polarizing beam splitter 19. As a result of its rotated polarization direction, this transmitted light is then reflected at polarizing beam splitter 19 toward mirror 29, which reflects the transmitted light passing along partial beam path 24 toward detector 4 (not shown). Illuminating light 1 of the light not influenced by λ/2 plate 20, first reflected at polarizing beam splitter 19, first passes along partial beam path 24; after having traversed λ/4 plate 26, microscope objective 8, specimen 6, microscope objective 7, and λ/4 plate 25, the polarization direction of this transmitted light is rotated 90 degrees. After reflection at mirror 27, the transmitted light passing along beam path 23 has a polarization direction that can pass through polarizing beam splitter 19 toward mirror 29. This transmitted light, too, is reflected toward detector 4 (not shown).

Light source 2 shown in FIG. 5 is a laser system that comprises an argon-krypton laser which can simultaneously emit light of three different wavelengths. Light source 2 furthermore comprises a pulsed laser light source that emits laser light with which multi-photon fluorescence can be excited.

The exemplary embodiments shown in FIGS. 1 through 4 focus illuminating light 1 into specimen 6. Beam deflection apparatus 12 deflects illuminating light beam 1 in two directions that are substantially perpendicular to one another so that the illumination focus can be moved relative to the specimen, thereby allowing the specimen to be scanned two-dimensionally. A movement along the optical axis of the specimen accommodation apparatus (not shown) allows three-dimensional data acquisition, as is common in confocal scanning microscopy.

In the exemplary embodiment of FIG. 2, the detected light is fluorescent light; in the exemplary embodiments of FIGS. 3 and 4, the detected light is transmitted light.

A photomultiplier arrangement, which comprises multiple detection channels with which light from different spectral regions can be detected, is provided as detector 4.

Microscope objectives 7, 8 are arranged opposite one another with respect to the specimen and to a common focal plane.

The exemplary embodiment shown in FIG. 2 is configured as a double confocal scanning microscope with which interferometric operation is possible on both the illumination and detection side. For interferometric illumination, the illuminating and detected beam path 1, 3 is tuned to the coherence properties of the illuminating and detected light. Two phase-modifying means 30, 31, which are arranged respectively in partial beam paths 23 and 24, are provided for this purpose. On the one hand, with phase-modifying means 30, 31 it is possible to adjust the illuminating light in such a way that constructive interference exists at the illumination focus of the two microscope objectives 7, 8; on the other hand, phase-modifying means 30, 31 can be used to compensate for the path length difference between the two partial beam paths 23, 24. This path length difference results from the fact that the one half 15 of illuminating beam path 1 is reflected at the mirror-coated region of glass plate 14, while the other portion 16 of illuminating beam path 1 passes through the glass plate. As a result, the optical paths of the two partial beam paths 23, 24 are different. The coherence length of the illuminating and detected light is greater than the path length difference between partial beam paths 23, 24.

FIG. 3 shows a further detector 32 which detects the transmitted light passing along partial beam path 24 that is not reflected by polarizing beam splitter 19 toward mirror 29. With this microscope configuration, detector 32 detects the light whose polarization direction has been modified by specimen 6. With the exemplary embodiments according to FIGS. 3 and 4, it is thus possible to perform birefringence measurements on specimens.

In FIG. 1, the reference character 33 indicates the mirror-coated region that reflects back into partial beam paths 23, 24 the portion of the light that propagates toward that surface. The fluorescent light yield for fluorescent microscopy applications can thereby be increased, assuming suitable methods are in place to suppress the unwanted contributions resulting from multiple reflection at mirror-coated surface 33. In FIGS. 1 and 4, lenses 36 that make possible an intermediate image are provided. Since the light beam is not proceeding in collimated fashion at this point, the mirror-coated region could be of convex or concave configuration so that after reflection, the light beam encountering surface 33 is reflected back into itself. Alternatively, component 5 could have no mirror-coated region. The beam emerging from component 5 could then be reflected into itself by means of a lens and mirror arrangement disposed after component 5.

In conclusion, be it noted very particularly that the exemplary embodiments discussed above serve merely to describe the teaching claimed, but do not limit it to the exemplary embodiments.

What is claimed is:

1. A microscope comprising:
a light source an illumination beam path,
a detector defining a detection beam path,
at least two microscope objectives arranged on opposite sides of a common focal plane within a specimen and each collecting detection light emanating from the specimen, and
an optical component combining the detection light into a detection beam path and wherein the optical component acts on a portion of cross section of the illuminating beam path and combines the detection light such that the combined detection light is guided in a largely lossless fashion to the detector.

2. The microscope as defined in claim 1, wherein the portion of cross section of the illuminating beam path the optical component acts on is substantially 50% of the entire beam cross section.

3. The microscope as defined in claim 1, wherein the optical component consists essentially of a mirror, a dichroic beam splitter, a partially mirror-coated glass plate and a polarizing beam splitter.

4. The microscope as defined in claim 1, wherein each of the microscope objectives has a entrance pupil and the optical component divides the illuminating light beam path such that the entrance pupils of the microscope objectives are at least largely illuminated.

5. The microscope as defined in claim 1, wherein the detection light coming from the specimen proceeds, after the optical component, in at least largely parallel fashion.

6. The microscope as defined in claim 1, wherein at least one laser is provided as the light source.

7. The microscope as defined in claim 1, wherein the light source is a lamp, preferably a mercury or xenon lamp.

8. The microscope as defined in claim 1, wherein the detection light is reflected light, transmitted light and fluorescent light.

9. The microscope as defined in claim 1, wherein the detector comprises a CCD chip, a CCD linear array, a photomultiplier, a photodiode or an avalanche photodiode.

10. The microscope as defined in claim 1, wherein the configuration of the microscope consists essentially of a double confocal scanning microscope, a standing wave field microscope, an I⁵M, I³M, or I²M microscope and a theta microscope.

11. The microscope as defined in claim 1, wherein at least one phase-modifying means, with which the phase relationship of the illumination and the detection light is modified for different points in the focal plane.

12. The microscope as defined in claim 1, wherein at least one dispersion-modifying means is arranged in a beam path segment between the optical component and the microscope objective.

13. A microscope comprising:
a light source defining an illumination beam path;
a detector defining a detection beam path,
at least two microscope objectives arranged on opposite sides of a common focal plane within a specimen and each collecting detection light emanating from the specimen, and
an optical component combining the detection light into a detection beam path and wherein the optical component is a polarizing beam splitter and acts on the entirety of cross section of the illumination and detection beam path.

14. The microscope as defined in claim 13, wherein a λ/2 plate is arranged between the light source and the polarizing beam splitter and that influences substantially 50% of the illumination beam path and the detection beam path cross section.

15. The microscope as defined in claim 13, wherein at least one means influencing the polarization direction is provided in a beam path segment between the polarizing beam splitter and at least one microscope objective.

16. The microscope as defined in claim 14, wherein the means influencing the polarization direction comprises one λ/2 plate or two λ/4 plates.

17. The microscope as defined in claim 13, wherein a further beam splitter is arranged between the detector and the λ/2 plate, by way of which the light coming from the specimen can be conveyed to a detector.

18. The microscope as defined in claim 13, wherein at least one laser is provided as the light source.

19. The microscope as defined in claim 18, wherein the laser light source emits pulsed light.

20. The microscope as defined in claim 13, wherein the illumination light is focused into the specimen and defining an illumination focus.

21. The microscope as defined in claim 20, wherein the illumination focus is moved relative to the specimen by deflection of the illuminating light beam by a beam deflection apparatus.

22. The microscope as defined in claim 13, wherein the detection light is reflected light, transmitted light and fluorescent light.

23. The microscope as defined in claim 13, wherein the detector consists essentially of a CCD chip, a CCD linear array, a photomultiplier, a photodiode, or an avalanche photodiode.

24. The microscope as defined in one of claim 13, wherein the configuration of the microscope consists essentially of a double confocal scanning microscope, a standing wave field microscope, an I⁵M, I³M, or I²M microscope and a theta microscope.

25. The microscope as defined in claim 13, wherein at least one phase-modifying means is arranged in a beam path segment between the polarizing beam splitter and the microscope objective.

26. The microscope as defined in claim 13, wherein at least one phase-modifying means, with which the phase relationship of the illumination and detection light is modifiable for different points in the focal plane, is provided.

27. The microscope as defined in claims 13, wherein at least one dispersion-modifying means is arranged in a beam path segment between the polarizing beam splitter and the microscope objective.

28. The microscope as defined in claim 13, wherein the illumination light can be at least partially, blocked out of the beam path in front of a microscope objective.

29. The microscope as defined in claim 13, wherein a further detector is arranged after the polarizing beam splitter, and the additional detector detects the light that is modified in terms of its polarization direction by the specimen.

30. The microscope as defined in claim 13, wherein a beam splitter cube is provided is used as the polarizing beam splitter and one lateral surface of beam splitter cube is at least partially mirror-coated.
